(19) United States
(12) Patent Application Publication
(10) Pub. No.: US 2009/0046315 A1
(43) Pub. Date: Feb. 19, 2009

(54) Unified determination of access to composite imaging service

(76) Inventors: Andrew R. Ferlitsch, Camas, WA (US); Joseph B. Murdock, Camas, WA (US)

Correspondence Address: SHARP LABORATORIES OF AMERICA, INC., 1320 PEARL ST., SUITE 228, BOULDER, CO, 80302, US

(21) Appl. No.: 11/893,668

(22) Filed: Aug. 17, 2007

(51) Int. Cl. G06F 3/12

(52) U.S. Cl. 358/1.15

(57) ABSTRACT

Methods and systems that enable unified determinations of access to composite imaging services. In some aspects, the invention provides a unified predetermination of access to a composite imaging service, e.g., a unified determination made before a print job is sent that an entity is authorized to access all component services of a composite print service. In other aspects, the invention provides a unified contemporaneous determination of access to a composite imaging service, e.g., a unified determination made in early stage processing of a print job that an entity is authorized to access all component services of a composite print service. In either event, such unified determinations save time and system resources relative to fragmented determinations of access to composite imaging services in prior systems that can result in rejection of imaging jobs after substantial processing has already been done.

### BACKGROUND OF THE INVENTION

The present invention relates to access to distributed imaging services and, more particularly, to methods and systems that enable unified determinations of access to composite imaging services.

In distributed imaging services environments, some imaging services are offloaded from an imaging node, such as a multifunction printer (MFP) to other network nodes, such as imaging server nodes. A logical group of imaging services, sometimes called a composite imaging service, is then formed from the on-board imaging services and the offloaded imaging services. As one of numerous examples, a printing service on a printing node may be combined into a composite print service with a format conversion service on a print server node that converts print jobs into a format native to the printing node so that a print job can be successfully output on the printing node. More generally, composite imaging services may be formed from a broad array of accounting, auditing, conversion, copying, displaying, faxing, filing, printing, publishing, scanning and stamping services, to name a few.

The component services of a composite imaging service may maintain their own access control lists. When they do, certain problems can arise. For example, in a composite print service in which some component services reside on a printing node and others reside on a print server node, the component services may have different authorized client or user lists. As a result, a print job submitted to the composite print service may be accepted and processed by the printing node only to be later rejected by the print server node for lack of authorization, or vice versa. This wastes time and system resources. Moreover, composite imaging services typically do not provide the client or user a mechanism for making an advance determination as to whether the client or user is authorized to access all component services of the composite imaging service.

### SUMMARY OF THE INVENTION

The present invention, in a basic feature, provides methods and systems that enable unified determinations of access to composite imaging services. In some aspects, the invention provides a unified predetermination of access to a composite imaging service, e.g., a unified determination made before a print job is sent that an entity is authorized to access all component services of a composite print service. In other aspects, the invention provides a unified early-stage determination of access to a composite imaging service, e.g., a unified determination made in early-stage processing of a print job that an entity is authorized to access all component services of a composite print service. In either event, such unified determinations save time and system resources relative to fragmented determinations of access to composite imaging services in prior systems that can result in rejection of imaging jobs after substantial processing has already been done.

In some aspects, the invention provides methods and systems for unified predetermination of access to composite imaging services using probe requests and responses. In one embodiment, a method comprises the steps of receiving on a node from an entity a probe request identifying one or more imaging services, authenticating by the node the entity, identifying on the node one or more imaging services corresponding to imaging services in the request including at least one composite imaging service, wherein the at least one composite imaging service has component services distributed among a plurality of nodes and wherein two or more of the component services have independent access control lists, determining on the node that the entity is authorized for the one or more corresponding imaging services including determining on the node that the entity is authorized for each of the two or more component services that have independent access control lists and transmitting by the node to the entity a probe response indicating authorization for the corresponding imaging services.

In another embodiment, a method comprises the steps of receiving on a node from an entity a probe request, authenticating by the node the entity, identifying on the node one or more imaging services, wherein the imaging services comprise at least one composite imaging service having component services distributed among a plurality of nodes and wherein two or more of the component services have independent access control lists, determining on the node that the entity is authorized for the imaging services including determining on the node that the entity is authorized for each of the two or more component services that have independent access control lists and transmitting by the node to the entity a probe response indicating authorization to the imaging services.

In some aspects, the invention provides methods and systems for unified administrative determination of access to composite imaging services using probe requests and responses. In one embodiment, a method comprises the steps of receiving on a node from an administrative entity a probe request for administrative level information on imaging services, authenticating by the node the administrative entity, identifying on the node one or more imaging services, wherein the identified imaging services comprise at least one composite imaging service having component services distributed among a plurality of nodes and wherein two or more of the component services have independent access control lists, determining on the node respective lists of authorized entities for the identified imaging services including determining on the node for each of the two or more component services that have independent access control lists which entities are authorized and transmitting by the node to the administrative entity a probe response identifying the identified imaging services and respective lists of authorized entities.

In other aspects, the invention provides methods and systems for unified determination of access to composite imaging services using service requests. In one embodiment, a method comprises the steps of receiving on a node from an entity an imaging service request, authenticating by the node the entity, identifying on the node one or more imaging services corresponding to imaging service request including at least one composite imaging service, wherein the at least one composite imaging service has component services distributed among a plurality of nodes and wherein two or more of the component services have independent access control lists, determining on the node that the entity is authorized for the one or more corresponding imaging services including determining on the node that the entity is authorized for each of the two or more component services that have independent access control lists and accepting the request.

The component services may comprise Web services (WS), for example.

The component services may comprise accounting, auditing, conversion, copying, displaying, faxing, filing, printing, publishing, scanning or stamping services, for example.

The entity may comprise a client computing device or a human user, for example.

The node that processes the request may comprise a printing node or a print server node, for example..

The plurality of nodes among which the component services are distributed may comprise a printing node and one or more print server nodes, for example.

The node that processes the request may discover authorized entities for the component services through manual input or auto-discovery, for example. Auto-discovery may be initiated by the node that processes the request or by the nodes that host the component services, for example.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 shows an imaging system in which the invention is operative in some embodiments.

FIG. 2 shows composite print services within the imaging system of FIG. 1.

FIG. 3 shows the printing node of FIG. 1 detailing entities involved in managing unified determinations of access to composite print services.

FIG. 4 shows a method for unified predetermination of access to composite print services using probe requests and responses in some embodiments of the invention.

FIG. 5 shows a method for unified predetermination of access to composite print services using probe requests and responses in other embodiments of the invention.

FIG. 6 shows a method for unified administrative determination of access to composite print services using probe requests and responses in some embodiments of the invention.

FIG. 7 shows a method for unified determination of access to composite print services using service requests in some embodiments of the invention.

### DETAILED DESCRIPTION OF A PREFERRED EMBODIMENT

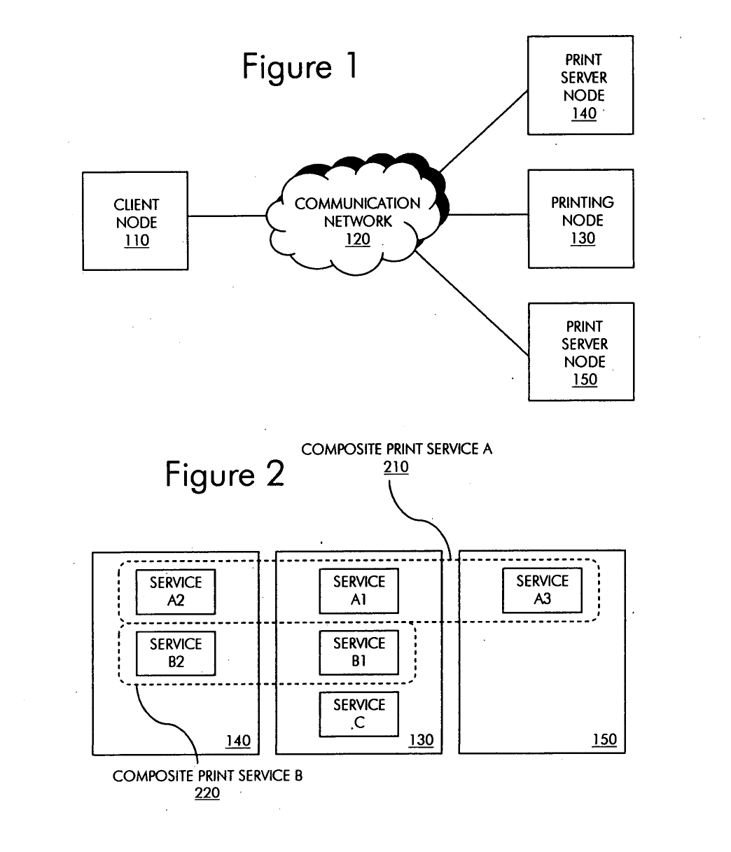

FIG. 1 shows an imaging system in which the invention is operative in some embodiments. The imaging system includes a client node 110 communicatively coupled with a printing node 130 over a communication network 120. Client node 110 is a data communication device, such as a desktop personal computer, laptop personal computer, workstation, remote terminal, cellular phone or personal data assistant (PDA), that is capable of generating specifications for probe requests and service requests, such as print jobs, and transmitting via a network interface, such as an Ethernet interface or a universal serial bus (USB) interface, probe requests and service requests conformant with the specifications to printing node 130. Communication network 120 is a data communication network that may include one or more wired or wireless LANS, WANs, WiMax networks, USB networks and/or ad-hoc networks each of which may have one or more-data communication nodes, such as switches, routers, bridges and hubs, operative to communicatively couple client node 110 and printing node 130. In some embodiments, communication network 120 traverses the Internet. While in the embodiments described in detail herein the imaging system is a printing system, the invention is also applicable to other imaging systems, such as scanning, copying and foxing systems.

Printing node 130 is a printing device having a wired or wireless network interface, such as an Ethernet interface or a USB interface, that communicatively couples printing node 130 with communication network 120. Printing node 130 is capable of receiving via the network interface probe requests and service requests initiated on client node 110, processing probe requests and service requests and outputting a hard copy of print jobs conformant with service requests by invoking internal print services. In some embodiments, printing node 130 is a multifunction printer (MFP) that supports multiple imaging services, such as scanning, copying and faxing. Printing node 130 also has a user interface for accepting inputs from a user and displaying output to a user. Internal to printing node 130, the user and network interfaces are communicatively coupled with a processor (CPU), a memory, a print engine and, in some embodiments, a scan, copy and/or fax engine. The print engine includes printer logic, such as one or more integrated circuits (IC), and a mechanical section for performing printing functions. For example, the print engine may have a color ink jet head mounted on a movable carriage for outputting a hard copy of print jobs under the control of a printer IC. In some embodiments, information associated with service requests is transmitted to one or more of print server nodes 140, 150 for additional processing by external print services before, during or after processing of service requests on printing node 130.

Printing node 130 is coupled via communication network 1 20 with print server nodes 140, 150. Print server nodes 140, 150 host external imaging services that enable, facilitate or extend the internal print services hosted on printing node 130. External print services may include accounting, auditing, format conversion, copying, displaying, faxing, filing, publishing, scanning or bates stamping services, for example. External print services hosted on print server nodes 140, 150 may be logically coupled with internal print services hosted on printing node 130 to form a composite print service. External and internal print services that are joined in a composite print service are sometimes referred to herein as component services of the composite print service. In some embodiments, component services of a composite print service comprise Web services (WS) that communicate via communication network 120 using eXtensible Markup Language (XML) messages that follow the Simple Object Access Protocol (SOAP) and related standards. In other embodiments, component services of a composite print service may communicate using other protocols, such as HyperText Transfer Protocol (HTTP). A composite print service may be created in various ways, such as serial physical or logical coupling of nodes, application of predefined coupling rules, inferences from the print services involved, or manual definition, for example.

A composite print service can be exposed such that one or more of a client node 110, client software installed on client node 110, or a user of client node 110 can request the composite print service. If a composite print service is exposed, the component services within the composite print service may or may not be separately exposed as composed or non-composed print services.

External print services within a composite print service may have independent access control lists (ACLs) whose membership differs from ACLs of other external and internal print services in the same composite print service, which can create non-uniform access control decisions. One important object of the present invention is eliminating these non-uniformities by enabling access determinations for composite print services to be made on printing node 130 in unified fashion.

Turning now to FIG. 2, composite print services within the printing system of FIG. 1 are shown by way of example. In the illustrated example, printing node 130 hosts internal print services A1, B1, C, while print server node 140 hosts external print services A2, B2 and print server node 150 hosts external print service A3. Print services A1, A2, A3 are logically coupled into composite print service A 210, within which print services A1, A2, A3 are component services. Print services B1, B2 are logically coupled into composite print service B 220, within which print services B1, B2 are component services. Print service C is a non-composite print service, that is, a standalone print service that is not logically coupled with any other print service. Each component service A1, A2, A3 within composite print service A 210 maintains an independent ACL whose membership may differ from the independent ACLs maintained by other component services, while each component service B1, B2 within composite print service B 220 similarly maintains an independent ACL whose membership may differ from the independent ACL of the other component service. Print service C also maintains an independent ACL. It bears noting that the sole print service within non-composite print service C is considered a component service of non-composite print service C, even though it is the only component service.

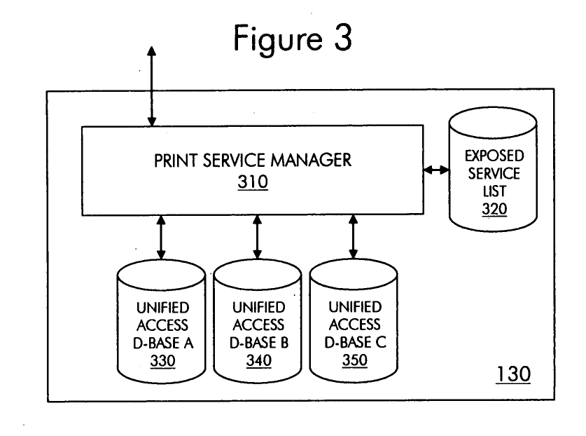

Turning now to FIG. 3, printing node 130 is shown detailing entities involved in managing unified determinations of access to composite print services. Printing node 130 includes a print service manager 310 that is communicatively coupled with an exposed print service list 320 and unified access databases 330, 340, 350, which store unified access data for composite print service A 210, composite print service B 210 and non-composite print service C, respectively. Print service manager 310 is a computer program executable on a central processing unit (CPU) of printing node 130. In the illustrated embodiment, exposed print service list 320 and unified access databases 330, 340, 350 reside in one or more memories of printing node 130, although in other embodiments some or all of these data stores may reside on an external network node or a removable storage element.

Exposed print service list 320 stores identities of composite and non-composite print services that are exposed on printing node 130. Continuing with the example of FIG. 2, exposed print service list 320 includes an identifier of composite print service A 210, an identifier of composite print service B 220 and an identifier of non-composite print service C, all of which are exposed to client node 110. Exposed composite print services and their respective component services, as well as exposed non-composite print services, may be configured on printing node 130 through manual data entry, for example.

Unified access databases 330, 340, 350 store authentication information for entities authorized to use exposed composite print service A 210, composite print service B 220 and non-composite print service C, respectively. Authorized entities may include client nodes, client software or human users, for example. Where the authorized entities include client nodes, the authentication information may include authorized machine addresses, machine identifiers and/or machine certificates, for example. Where the authorized entities include human users, the authentication information may include authorized usernames, passwords, user certificates and/or biometric information, for example. In some embodiments, unified access database 330 for composite print service A 210 separately maintains authentication information for the authorized entities of each component service A1, A2, A3 within composite print service A 210. Similarly, in some embodiments, unified access database 340 for composite print service B 220 separately maintains authentication information for the authorized entities of each component service B1, B2 within composite print service B 220. Printing node 130 may discover authentication information respecting authorized entities of component services of composite print services, as well as of non-composite print services, through auto-discovery or manual data entry, for example. Auto-discovery of authentication information for authorized entities of external print services may be initiated by printing node 130, for example, by querying print server nodes 140, 150 via communication network 120 for the ACL contents of each of their print services. Alternatively, auto-discovery of authentication information for authorized entities of external print services may be initiated by print server nodes 140, 150, for example, by registering with printing node 130 via communication network 120 the ACL contents of each of their print services. Auto-discovery may be periodic or event-driven. Naturally, a secure communication protocol is used to ensure that authentication information is not compromised while in transit.

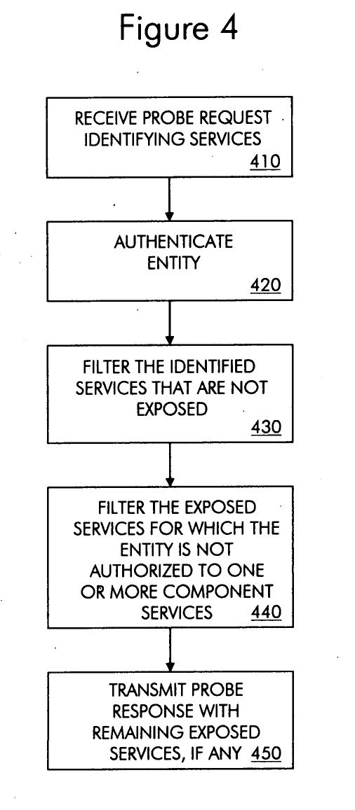

FIG. 4 shows a method for unified predetermination of access to composite print services using probe requests and responses in some embodiments of the invention. An entity, which may be client node 110, client software installed on client node 110 or a human user of client node 110, initiates a probe request that identifies exposed print services to which the entity wishes to discover its access privileges in advance of sending a print job (410). For example, continuing with the exemplary arrangement of FIGS. 2 and 3, such a probe request may identify composite print service A 210, composite print service B 220 and/or non-composite print service C. The probe request may be unicasted to printing device 130 using a known destination address of printing device 130, or may be broadcasted or multicasted.

Printing device 130 receives the probe request and print service manager 310 authenticates the entity (420). Authentication may be accomplished using any of numerous mechanisms. In some embodiments, for example, the probe request has encrypted authentication information that is decrypted by print service manager 310 and then compared with authentication information maintained in a database of authorized entities. Such authentication information may be stored in a memory on printing node 130, for example. In any event, if print service manager 310 is unable to authenticate the entity, print service manager 310 rejects the probe request and, in some embodiments, returns a probe response to the entity indicating an authentication failure.

If print service manager 310 successfully authenticates the entity, print service manager 310 accepts the probe request and filters any print services identified in the probe request that are not within exposed print service list 320 (430). Print service manager 310 compares print service identifiers included in the probe request with print service identifiers stored in exposed print services list 320 and filters print services identified in the probe request for which no match is found. For example, returning to the arrangement of FIGS. 2 and 3, if the print services identified in the probe request are A, C and D, print service manager 310 would fail to find a match for D and thus would filter D. Print service manager 310 would, however, find a match for A and C and thus would not filter A or C.

Next, print services manager 310 filters the remaining print services identified in the probe request for which the entity is not authorized (440). Print service manager 310 consults the ones of unified access databases 330, 340, 350 that correspond to the print services identified in the probe request that remain after Step 430 and compares the authentication information included in the probe request with the authentication information in the corresponding ones of unified access databases 330, 340, 350. Print service manager 310 then filters remaining print services identified in the probe request for which no match is found. It bears noting that for any composite print services identified in the probe request that remain after Step 430, authorization is required for each component service of the composite print service in order for the composite print service to avoid being filtered. For example, continuing the above example, print service identifiers A and C from the probe request remain after Step 430. Of these, print service A is a composite print service that includes component services A1, A2, A3. Print service manager 310 thus in some embodiments searches unified access database 330 for a match of authentication information in the probe request with authentication information stored in unified access database 330 for each component service A1, A2, A3. If a match is not found for any one of component services A1, A2, A3, print service A is filtered from the probe request. If a match is found for each of component services A1, A2, A3, print service A is not filtered. In other embodiments, unified access database 330 may be arranged to include a composite list having authentication information only for entities that have access privileges for all component services A1, A2, A3. In such embodiments, print services manager 310 searches for a match of authentication information in the probe request with authentication information in the composite list. If a match is not found in the composite list, print service A is filtered from the probe request and is otherwise retained. Naturally, print service manager 310 also searches the authentication information in unified access database 350 associated with non-composite print service C for a match with authentication information received in the probe request and filters or retains print service C according to the result.

Finally, printing node 130 under control of print service manager 310 transmits to client node 110 a probe response identifying the print services remaining after Step 440 (450). The probe response advantageously informs client node 110 or a user thereof, in advance of sending a print job requiring the print services that were identified in the probe request, whether the print job would be accepted or rejected.

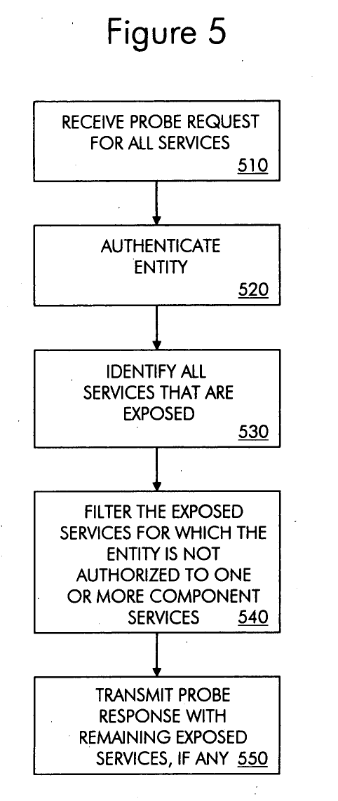

FIG. 5 shows a method for unified predetermination of access to composite print services using probe requests and responses in other embodiments of the invention. In these embodiments, a probe request is targeted to reveal in advance of sending a print job an initiating entity's access privileges to all print services exposed on printing node 130, not merely specific print services identified in a probe request.

The entity initiates a probe request in advance of sending a print job (510). Printing device 130 receives the probe request and print service manager 310 authenticates the entity (520). If print service manager. 310 is unable to authenticate the entity, print service manager 310 rejects the probe request and, in some embodiments, returns a probe response to the entity indicating an authentication failure. If print service manager 310 is able to successfully authenticate the entity, print service manager 310 accepts the probe request and identifies all services within exposed print services list 320 (530). For example, returning once again to the arrangement shown in FIGS. 2 and 3, print services A, B, C are exposed and identified. Next, print services manager 310 filters the exposed print services for which the entity is not authorized to one or more component services (540). For example, continuing the above example, print services A, B, C are identified in Step 530. Print service manager 310 thus searches unified access database 330 for a match of authentication information received in the probe request with authentication information stored in unified access database 330 for each component service A1, A2, A3, or stored in a composite list for all component services A1, A2, A3. If a match is not found, print service A is filtered from the identified services. If a match is found, print service A is retained. Similarly, print service manager 310 searches in unified access database 340 for composite print service B 220 and in unified access database 350 for non-composite print service C for respective matches with authentication information received in the probe request and retains or filters identified print services B, C according to the respective results. Finally, printing node 130 under control of print service manager 310 transmits to client node 110 a probe response identifying the print services remaining after Step 540 (550). The probe response advantageously informs client node 110 or a user thereof, in advance of sending any print job requiring print services of printing node 130, whether the print job would be accepted or rejected.

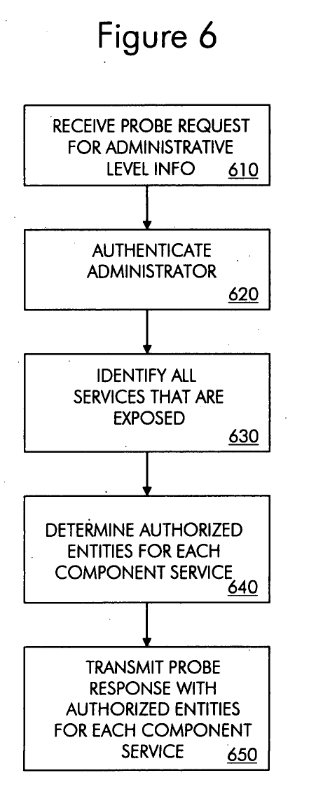

FIG. 6 shows a method for unified administrative determination of access to composite print services using probe requests and responses. In these embodiments, a probe request initiated by an administrator is targeted to reveal access privileges of all system entities to all print services exposed on printing node 130.

An administrative entity initiates a probe request (610). Printing device 130 receives the probe request and print service manager 310 authenticates the administrative entity (620). In some embodiments, the probe request has encrypted authentication information that is decrypted by print service manager 310 and then compared with authentication information maintained for authorized administrative entities. After successful authentication, print service manager 310 accepts the probe request and identifies all services within exposed print services list 320 (630). For example, returning to the arrangement of FIGS. 2 and 3, print services A, B, C are exposed and identified. Next, print services manager 310 determines the authorized entities for each identified service (640). For example, print service manager 310 extracts from unified access database 330 authentication information for each component service A1, A2, A3, extracts from unified access data 340 authentication information for each component service B1, B2 and extracts from unified access data 350 authentication information for non-composite service C. Finally, printing node 130 under control of print service manager 310 transmits to the administrative entity that initiated the probe request one or more probe responses identifying the print services within exposed print services list 320 and authentication information for each exposed print service (650). It will be appreciated that for composite print services, authentication information may be separately provided for each component service. The probe responses advantageously inform the administrator about current access privileges on a system-wide basis, which information can be advantageously applied to troubleshoot system problems and improve system performance, for example.

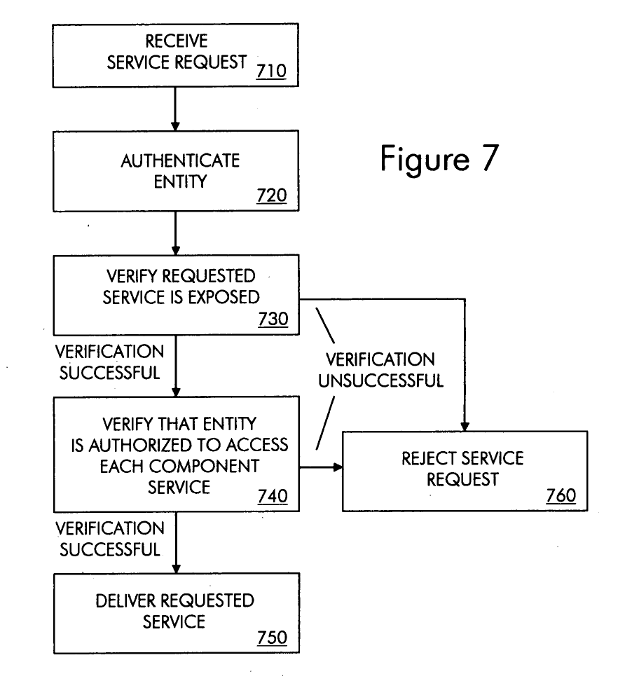

FIG. 7 shows a method for unified determination of access to composite print services using service requests. An entity, which again may be client node 110, client software installed on client node 110 or a human user of client node 110, initiates a request for print services, for example, output and accounting of a print job (710). For example, continuing with the exemplary arrangement of FIGS. 2 and 3, the service request may request the services of composite print service B 220 in which component service B1 hosted on printing node 130 is a printing service and component service B2 hosted on print server node 140 is an accounting service. The probe request is unicast to printing device 130 using a known destination address of printing device 130.

Printing device 130 receives the service request and print service manager 310 authenticates the entity (720). If print service manager 310 is unable to authenticate the entity, print service manager 310 rejects the service request and, in some embodiments, returns a service response to the entity indicating an authentication failure.

If print service manager 310 is able to successfully authenticate the entity, print service manager 310 next verifies that the service request is directed to an exposed print service by reference to exposed print service list 320 (730). Print service manager 310 decomposes the service request to determine the services still to be processed and compares them with print services stored in exposed print service list 320. If the requested print services are not within exposed print service list 320, print service manager 310 rejects the service request and, in some embodiments, returns a service response to the entity indicating a failure for unavailability of the requested print services (760). Continuing the above example, composite print service B is requested here and would be found within exposed print service list 320.

Next, print services manager 310 verifies that the entity is authorized for the requested print services (740). Print service manager 310 consults ones of unified access databases 330, 340, 350 that correspond to the requested print services and compares the authentication information included in the service request with the authentication information in the corresponding ones of unified access databases 330, 340, 350. For example, continuing the above example, composite print service B is identified in Step 730. Print service manager 310 thus searches unified access database 340 for a match of authentication information received in the service request with authentication information stored in unified access database 340 for each component service B1, B2, or stored in a composite list for all component services B1, B2. If the authentication information is not found in unified access database 340, print service manager 310 rejects the service request and, in some embodiments, returns a service response to the entity indicating an authorization failure (760).

Finally, if print services manager 310 is able to successfully verify that the entity is authorized for the print services in the service request, printing node 130 under control of print service manager 310 delivers the requested services (750).

In some embodiments, component services of a composite print service may be separately exposed as either composite or non-composite services, in which case such separately exposed services are separately listed in the exposed print service list and in which case a unified access database is separately maintained for such services.

It will be appreciated by those of ordinary skill in the art that the invention can be embodied in other specific forms without departing from the spirit or essential character hereof. For example, while the described embodiments have involved composite print services, the invention can be applied to composite services that have independent ACLs but do not involve printing. The present description is therefore considered in all respects to be illustrative and not restrictive. The scope of the invention is indicated by the appended claims, and all changes that come with in the meaning and range of equivalents thereof are intended to be embraced therein.

What is claimed is:

1. A method for unified predetermination of access to a composite imaging service, comprising the steps of:
receiving on a node from an entity a probe request;
authenticating by the node the entity;
identifying on the node one or more imaging services, wherein the imaging services comprise at least one composite imaging service having component services distributed among a plurality of nodes and wherein two or more of the component services have independent access control lists;
determining on the node that the entity is authorized for the imaging services including determining on the node that the entity is authorized for each of the two or more component services that have independent access control lists; and
transmitting by the node to the entity a probe response indicating authorization to the imaging services.

2. The method of claim 1, wherein the probe request identifies one or more imaging services and the node transmits to the entity a probe response indicating authorization to the imaging services identified in the probe request.

3. The method of claim 1, wherein the component services comprise Web services.

4. The method of claim 1, wherein the component services comprise an accounting, auditing, conversion, copying, displaying, foxing, filing, printing, publishing, scanning or stamping service.

5. The method of claim 1, wherein the entity comprises a human user.

6. The method of claim 1, wherein the entity comprises a client computing device that is used by a human user.

7. The method of claim 1, wherein the plurality of nodes comprise a printing node and a print server node.

8. The method of claim 1, wherein the node auto-discovers authorized entities for at least one of the component services through communication with another node.

9. A method for unified administrative determination of access to a composite imaging service, comprising the steps of:
receiving on a node from an administrative entity a probe request for administrative level information on imaging services;
authenticating by the node the administrative entity;
identifying on the node one or more imaging services, wherein the identified imaging services comprise at least one composite imaging service having component services distributed among a plurality of nodes and wherein two or more of the component services have independent access control lists;
determining on the node respective lists of authorized entities for the identified imaging services including determining on the node for each of the two or more component services that have independent access control lists which entities are authorized; and
transmitting by the node to the administrative entity a probe response identifying the identified imaging services and respective lists of authorized entities.

10. The method of claim 9, wherein the component services comprise Web services.

11. The method of claim 9, wherein the component services comprise an accounting, auditing, conversion, copying, displaying, faxing, filing, printing, publishing, scanning or stamping service.

12. The method of claim 9, wherein the administrative entity comprises a human user.

13. The method of claim 9, wherein the entity comprises a client computing node that is used by a human user.

14. The method of claim 1, wherein the plurality of nodes comprise a printing node and a print server node.

15. The method of claim 1, wherein the node auto-discovers authorized entities for at least one of the component services through communication with another node.

16. A method for unified determination of access to a composite imaging service, comprising the steps of:
receiving on a node from an entity an imaging service request;
authenticating by the node the entity;
identifying on the node one or more imaging services corresponding to the imaging service request including at least one composite imaging service, wherein the at least one composite imaging service has component services distributed among a plurality of nodes and wherein two or more of the component services have independent access control lists;
determining on the node that the entity is authorized for the one or more corresponding imaging services including determining on the node that the entity is authorized for each of the two or more component services that have independent access control lists; and
accepting the imaging service request.

17. The method of claim 16, wherein the component services comprise Web services.

18. The method of claim 16, wherein the component services comprise an accounting, auditing, conversion, copying, displaying, faxing, filing, printing, publishing, scanning or stamping service.

19. The method of claim 16, wherein the entity comprises a human user or a client computing node that is used by a human user.

20. The method of claim 16, wherein the node auto-discovers authorized entities for at least one of the component services through communication with another node.
